(19) United States
(12) Patent Application Publication
(10) Pub. No.: US 2012/0117133 A1
(43) Pub. Date: May 10, 2012

(54) METHOD AND DEVICE FOR PROCESSING A DIGITAL SIGNAL

(75) Inventors: Félix Henry, Rennes (FR); Christophe Gisquet, Rennes (FR); Isabelle Corouge, Rennes (FR)

(73) Assignee: CANON KABUSHIKI KAISHA, Tokyo (JP)

(21) Appl. No.: 13/322,145

(22) PCT Filed: May 27, 2010
(86) PCT No.: PCT/EP2010/057367

§ 371 Date: Jan. 19, 2012

(30) Foreign Application Priority Data
May 27, 2009 (GB) 0909005.1
May 27, 2009 (GB) 0909007.7

(51) Int. Cl. G06F 17/17

(52) U.S. Cl. 708/203; 708/313

(57) ABSTRACT

A method for processing a digital signal comprises receiving an output encoded signal (S_{d},s_{c}) obtained from an original digital signal (Sᵢ) having an initial spatial resolution and an initial bit rate, the output encoded signal having a bitrate lower than the initial bitrate, processing the output encoded signal to obtain a source signal (Sᵥ) having the initial spatial resolution, and dividing (E303) samples of the source signal into at least two subsets of samples, the subsets corresponding respectively to different spatial grids that are arranged so that at least some samples of one subset are interleaved spatially with at least some samples of another said subset. Further, for each said subset, the method comprises determining (E305, E309, E311), for at least one sample of the subset, at least one filter amongst a set of predetermined filters according to a first predetermined criterion and finally inserting (E310) in a side information signal information representative of the filter(s) determined for the samples of the subset concerned. The method is suitable for encoding an original digital signal into an output encoded signal and a side information signal, the original digital signal having an initial resolution and an initial bitrate.

The invention relates to a method and device for processing a digital signal, in particular a digital video signal, and a method and device for decoding a digital video signal.

The invention belongs to the domain of digital signal processing in general and more particularly to the domain of encoding a digital signal in view of obtaining a good quality upsampled video signal.

A digital signal, such as for example a digital video signal, is generally captured by a capturing device, such as a digital camcorder, having a high quality sensor. Given the capacities of the modern capture devices, an original digital signal is likely to have a very high resolution, and, consequently, a very high bitrate. Such a high resolution, high bitrate signal is too large for convenient transmission over a network and/or convenient storage.

In order to solve this problem, it is known in the prior art to compress the original video signal into a compressed bitstream. The compression might consist in simply downsampling the digital signal, in particular if it is known that the client devices which receive and decode the compressed video signal have a given resolution capacity, lower than the initial resolution.

However, it is common nowadays to transmit digital data, in particular digital videos, through a telecommunication network to a plurality of receiving client devices which have various display capacities. In particular with the development of high definition display screens, more and more client devices are likely to have the capacity for displaying video data at high spatial resolution.

It is therefore desirable to be able to decode a digital signal having a very good quality from a compressed signal, and in particular to obtain a high resolution signal with good visual quality from a lower resolution signal.

The document ‘Fast adaptive upscaling of low structured images using a hierarchical filing strategy’ by Askar et al., in the proceedings of the conference ‘Video/image Processing and Multimedia Communications IEEE-EURASIP, 2002’, presents a method for upscaling digital images based on block subdivision and incremental reconstruction of a higher resolution image. However, this solution is only adapted for low structured images, and does not apply to a variety of natural gray level images. Because it is computationally intensive, it does not apply to video data processing.

Alternatively, it is possible to compress an original digital signal at the highest resolution to obtain an encoded signal having a lower bitrate that can be easily transmitted and stored, the encoded signal being decoded at a client device. For example, the video compression standard H264 may be applied.

However, there is still room for improvement of the quality of the decoded digital signal at a given compression rate.

The document EP 1 911 293 discloses a method of filtering a multi-dimensional signal using oriented filters. For each filter, a filter orientation is chosen from a plurality of possible orientations. The method proposed in EP1911293 takes into account local variations of the multidimensional filter so as to increase the filtering performance. The orientations, determined for each sample of the multidimensional signal to be filtered according to an optimization criterion, need to be transmitted along with the coded signal in order for this signal to be decoded. These orientations form a side information signal, which needs to be efficiently compressed to achieve a rate distortion improvement.

It is desirable to solve one or more of drawbacks of the prior art. It is also desirable to provide a method of encoding of a digital signal, particularly adapted to reconstruct a high resolution and high quality signal from the encoded signal, for any given original digital signal. To that end, a first aspect of the invention concerns a signal processing method, comprising the steps of:
receiving an output encoded signal obtained from an original digital signal having an initial spatial resolution and an initial bitrate, the output encoded signal having a bitrate lower than the initial bitrate,
processing the output encoded signal to obtain a source signal having the initial spatial resolution,
dividing samples of the source signal into at least two subsets of samples, the subsets corresponding respectively to different spatial grids that are arranged so that at least some samples of one subset are interleaved spatially with at least some samples of another said subset,
and, for each said subset:
   determining, for at least one sample of the subset, at least one filter amongst a set of predetermined filters according to a first predetermined criterion, inserting, in a side information signal, information representative of the filter(s) determined for the samples of the subset concerned.

The method of the invention finds a particularly advantageous application for digital signal compression, that is optimized with respect to the compression rate and the quality of the decoded signal at the same resolution as the original digital signal. The method of the invention finds a particularly advantageous application in the upsampling of digital signals, in particular digital video signals, since it provided a good rate-distortion compromise with a relatively low computational cost.

Advantageously, the first predetermined criterion is a rate-distortion cost, the distortion being calculated between the samples of the source signal and the corresponding samples of the original digital signal. Typically, the corresponding samples are samples at the same spatial position for a two-dimensional signal and at the same spatio-temporal position for a three-dimensional signal (e.g. space and time dimensions). Thus, a rate-distortion optimization is achieved.

According to a particular embodiment, the output encoded signal is obtained by down-sampling the original signal to a down-sampled signal having a resolution lower than the initial resolution.

In this case, the method is particularly adapted to an application to upsampling on a client device receiving the encoded digital signal, while the digital signal transmitted and/or stored has a high compression rate.

According to a particular feature of this embodiment, the source signal is obtained by up-sampling the down-sampled signal at the initial resolution to obtain said source signal.

The source signal used is thus at the same resolution as the original digital signal, allowing efficient processing.

In a variant, the output encoded signal is obtained by compressing the down-sampled signal.

Advantageously, any compression method may be applied at this stage, remaining compatible with the processing method proposed. Indeed, this makes the processing method proposed very easy to adapt to any client device implementing a particular compression method.

According to a particular feature, the obtaining of a source signal further comprises decompressing the compressed down-sampled signal before up-sampling.

Consequently, the source signal used at the encoding stage is the same as the one used at the decoding stage.

According to a particular embodiment, before the step of dividing the samples of the source signal into subsets, the dividing of the source signal into a plurality of blocks is applied, and the subsequent steps are applied to each block of samples, each block and grid division defining a subset of samples to be processed.

The block processing makes the method efficient in terms of memory consumption.

According to a particular feature, the step of determining at least one filter comprises:
determining an optimal context function amongst a plurality of context functions for the subset of samples to be processed, and a subset of filters associated to said optimal context function, a context function being a function that, for a given sample, takes into account a predetermined number of other samples and outputs a context value amongst a predetermined number of context values.

The use of context functions takes advantage of the local characteristics of the digital signal being processed and leads to achieving a higher compression rate.

According to another particular feature, a filter table is associated to the optimal context function determined, a filter being associated to each possible context value.

According to an embodiment, the step of determining an optimal context function comprises:

a step of determining a context function cost and a context function associated filter table for a context function of the plurality of context functions comprising:

calculating the value of the context function for each sample of the subset of samples to be processed;

dividing the samples of the subset to be processed into a set of sub-signals corresponding respectively to the various context values of said context functions;

and, for each sub-signal:

determining an optimal filter according to a second criterion that depends on the values of the sub-signal; and

memorizing said optimal filter associated with the context value taken by the context function on the sub-signal.

Advantageously, the second criterion consists in selecting the filter that minimizes a rate-distortion cost a predetermined rate being associated to each filter and a distortion being computed between the filtered samples of the sub-signal and the corresponding samples of the original signal. Typically, the corresponding samples are samples at the same spatial position for a two-dimensional signal and at the same spatio-temporal position for a three-dimensional signal (e.g. space and time dimensions).

According to a particular embodiment, the cost of the context function is computed as the sum of minimum rate-distortion costs associated to each optimal filter selected for each context value of the context function.

Thus, the rate-distortion of the encoded signal is further optimized.

According to a particular feature, the step of determining a context function cost and a context function associated filter table is carried out for each context function of the plurality of context functions.

Advantageously, the determining of an optimal context function associated to the samples to be processed further comprises selecting the context function having the minimum context function cost.

According to a particular feature, after the step of determining an optimal context function associated to the samples to be processed, the method comprises the steps of:
filtering the samples to be processed to obtained a set of filtered samples,
verifying whether a third criterion is satisfied, and
in case of positive verification, iterating the steps of determining an optimal context function and of filtering the samples to be processed, wherein the samples to be processed consist in the set of filtered samples. In case of negative verification, the number of iterations carried out is recorded in the side information signal.

Advantageously, the third criterion is the improvement of a rate-distortion cost calculated using the set of filtered samples as compared to a rate-distortion cost previously memorized.

Indeed, this insures that the rate-distortion cost is minimized, since it is verified that there is an improvement in terms of rate-distortion cost compared to the rate-distortion cost calculated on the set of samples previous to filtering.

According to a particular embodiment, the information representative of the filters comprises an index of the optimal context function determined and the associated filter table.

Thus, the optimal context function determined for a current grid and its associated context table are kept in the side information signal, to be subsequently used for improving the quality of the output encoded signal.

According to an embodiment, the side information signal is compressed, which further improves the overall compression of the encoded digital signal.

According to a particular feature, a bitstream corresponding to the encoded original digital signal is formed by concatenation of the output encoded signal and of the compressed side information signal.

According to a second aspect, the invention concerns a method for decoding a digital signal from a bitstream comprising an encoded digital signal and a side information signal, the method comprising the steps of:

obtaining, from the encoded digital signal, a source signal at a given target resolution,

dividing the samples of the source signal into at least two subsets of samples, the subsets corresponding respectively to different spatial grids that are arranged so that at least some samples of one subset are interleaved spatially with at least some samples of another said subset, and, for each said subset:

obtaining from the side information signal, for at least one sample of the subset, an information representative of a filter amongst a set of predetermined filters

filtering said at least one sample using the filter obtained.

The decoding method allows the decoding of the encoded bitstream obtained according to the processing method. In particular, the decoding method provides an upsampling of the received encoded digital signal, which has a visual quality close to the original digital signal visual quality.

According to a third aspect, the invention concerns a signal processing device comprising:
means for receiving an output encoded signal obtained from an original digital signal having an initial spatial resolution and an initial bit rate, the output encoded signal having a bitrate lower than the initial bitrate,
means for processing the output encoded signal to obtain a source signal having the initial spatial resolution,
means for dividing samples of the source signal into at least two subsets of samples, the subsets corresponding respectively to different spatial grids that are arranged so that at least some samples of one subset are interleaved spatially with at least some samples of another said subset,
means for determining, for at least one sample of the subset, at least one filter amongst a set of predetermined filters according to a first predetermined criterion,
means for inserting in a side information signal information representative of the filter(s) determined for the samples of the subset concerned.

The device for processing a digital signal has the same advantages and characteristics as the corresponding method for processing an original digital signal according to the invention, therefore they are not reminded here.

According to a fourth aspect, the invention concerns a device for decoding a digital signal from a bitstream comprising an encoded digital signal and a side information signal, comprising:
means for obtaining, from the encoded digital signal, a source signal at a given target resolution,
means for dividing the samples of the source signal into at least two subsets of samples, the subsets corresponding respectively to different spatial grids that are arranged so that at least some samples of one subset are interleaved spatially with at least some samples of another said subset, and, for each said subset:
means for obtaining from the side information signal, for at least one sample of the subset, an information representative of a filter amongst a set of predetermined filters, and
means for filtering said at least one sample using the filter obtained.

The device for decoding a digital signal has the same advantages and characteristics as the corresponding method for decoding a digital signal according to the invention, therefore they are not reminded here. A fifth aspect of the invention provides an information storage means that can be read by a computer or a microprocessor, this storage means being totally or partially removable, and storing instructions of a computer program for the implementation of the method of processing a digital signal embodying the aforesaid first aspect of the present invention. A sixth aspect of the invention provides a similar information storage means storing instructions of a computer program for the implementation of a method of decoding a digital signal embodying the aforesaid third aspect of the present invention.

A seventh aspect of the invention also relates to a computer program product that can be loaded into a programmable apparatus, comprising sequences of instructions for implementing a method of processing a digital signal embodying the aforesaid first aspect of the present invention, when the program is loaded into and executed by the programmable apparatus. An eighth aspect of the invention provides a similar computer program product having instructions for implementing a method of decoding a digital signal embodying the aforesaid third aspect of the present invention.

A tenth aspect of the invention provides a side information signal which is useful to a decoder. The side information signal may be supplied to the decoder in a number of ways. Preferably, the side information signal is supplied to the decoder in the same way as the output encoded signal. For example, the output encoded signal and the side information signal may be supplied to the decoder via a network. Alternatively, the two signals may be stored on a recording medium such as a DVD or other storage medium. The side information signal may be combined with the output encoded signal to produce a combined encoded signal. This combined encoded signal may then be transmitted via a network or stored on a recording medium. The recording medium may be a portable recording medium. Thus, an eleventh aspect of the present invention also provides a carrier medium carrying a side information signal embodying the invention or carrying such a combined encoded signal. The carrier medium may be a recording medium or a storage medium.

The particular characteristics and advantages of the storage means and of the computer program product being similar to those of the digital signal processing and decoding methods, they are not repeated here.

It is also desirable to achieve a better compression rate of a side information signal in an encoding scheme implying signal filtering using a plurality of filters.

To that end, a twelfth aspect of the invention provides a method for encoding information representative of filters for filtering a digital signal, wherein a filter to be applied to a sample of the digital signal is determined as a function of the value of a context function for said sample, wherein a context function is a function that, for a given sample, takes into account a predetermined number of other samples and outputs a context value amongst a predetermined number of context values. The method comprises the steps of:
dividing samples of the digital signal into at least two subsets of samples, the subsets corresponding respectively to different spatial grids that are arranged so that at least some samples of one said subset are interleaved spatially with at least some samples of another said subset,
for each said subset of samples, determining an optimal context function associated with the subset of samples concerned according to a first criterion, and a subset of filters associated to said optimal context function,
grouping items of information representative of the determined filters as a function of the corresponding optimal context function and the subset of samples into side information sub-signals, and
encoding each side information sub-signal thus obtained.

This is particularly advantageous since it was shown experimentally that the sub-signal contains items of information related to a particular grid number and context function have similar statistics, and therefore the compression can be largely improved by grouping items of information having similar statistics into sub-signals.

According to an embodiment, in the encoding step, at least two side information sub-signals are encoded independently. In particular, specific entropy encoders may be designed for each sub-signal. Advantageously, the overall compression of the information representative of filters for filtering a digital signal is improved.

According to a particular feature, before the step of dividing the samples of digital signal into subsets, a step of dividing the digital signal into blocks, wherein the steps of dividing the samples into at least two subsets and of determining an optimal context function (E305) are applied for each block of samples. Processing a digital signal by blocks is in particular advantageous for memory saving.

According to a particular embodiment, a filter table is associated to the optimal context function determined, a filter being associated to each possible context value.

This characteristic allows a very practical way to determine filters adapted to the local characteristics of a digital signal. In a particular embodiment, oriented filters are used.

According to particular features, the step of determining an optimal context function a step of determining a context function cost and a context function associated filter table for a context function of a plurality of context functions. The determining of the context function cost and the associated filter table further comprises:
calculating the value of the context function for each sample of the subset of samples to be processed;
dividing the samples of the subset to be processed into a set of sub-signals corresponding respectively to the various context values of said context functions;

and, for each sub-signal:
determining an optimal filter according to a second criterion that depends on the values of the sub-signal; and
memorizing said optimal filter associated with the context value taken by the context function on the sub-signal.

In particular, the second criterion consists in selecting the filter that minimizes a rate-distortion cost, a predetermined rate being associated to each filter and a distortion being computed between the filtered samples of the sub-signal and the corresponding samples of a target signal.

In an advantageous embodiment, the target signal is an original digital signal of high resolution to encode.

According to a particular feature, the cost of the context function is computed as the sum of minimum rate-distortion costs associated to each optimal filter selected for each context value of the context function.

By choosing locally the minimum rate-distortion cost, this ensures that the global rate-distortion cost is also minimized.

According to an embodiment, the step of determining a context function cost and a context function associated filter table is carried out for each context function of the plurality of context functions.

Exploring all context function available increases the chance of finding one that produces a low rate-distortion cost.

According to a particular feature, the determining of an optimal context function associated to the samples to be processed further comprises selecting the context function having the minimum context function cost.

This ensures that the context function choice contributes to the overall compression efficiency of the method.

According to particular characteristics, the method further comprises, after the step of determining an optimal context function associated to the samples to be processed, the steps of:
filtering the samples to be processed to obtained a set of filtered samples
verifying whether a rate-distortion cost calculated using the set of filtered samples is improved as compared to a rate-distortion cost previously memorized,
in case of positive verification, iterating the steps of determining an optimal context function and of filtering (E306) the samples to be processed, wherein the samples to be processed consist in the set of filtered samples.

This ensures that the rate-distortion cost is minimized.

Further, in case of negative verification, the number of iterations carried out is inserted in a first side information sub-signal, the first side information sub-signal being encoded independently.

According to an advantageous embodiment, the method of the invention further comprises gathering the indexes of the optimal context functions determined in a second side information sub-signal and encoding said second sub-signal independently. This feature allows a better adaptation compression rate.

According to particular features, the step of grouping items of information representative of the determined filters comprises concatenating filter tables corresponding to a given index of a subset of samples and a given context function in a third side information sub-signal.

It was indeed shown through experiments that, whatever the number of blocks or the number of iterations per block, gathering the filter tables depending on the grid index and the context function is sufficient for obtaining a good compression rate. Indeed, the filter tables related to context function and grid form a coherent statistical source, which makes entropy encoding more efficient.

According to a thirteenth aspect, the invention concerns a device for encoding information representative of filters for filtering a digital signal, wherein a filter to be applied to a sample of the digital signal is determined as a function of the value of a context function for said sample, wherein a context function is a function that, for a given sample, takes into account a predetermined number of other samples and outputs a context value amongst a predetermined number of context values. The device comprises:
means for dividing the samples of the digital signal into at least two subsets of samples, the subsets corresponding respectively to different spatial grids that are arranged so that at least some samples of one said subset are interleaved spatially with at least some samples of another said subset,
means, for determining an optimal context function associated with the subset of samples concerned according to a first criterion, and a subset of filters associated to said optimal context function,
means for grouping items of information representative of the determined filters as a function of the corresponding optimal context function and the subset of samples into side information sub-signals, and
means for encoding each sub-signal thus obtained.

The device for encoding information representative of filters for filtering a digital signal has the same advantages and characteristics as the corresponding method for encoding information representative of filters for filtering a digital signal, therefore they are not reminded here.

A fourteenth aspect of the invention also relates to an information storage means that can be read by a computer or a microprocessor, this storage means being totally or partially removable and storing instructions of a computer program for the implementation of the method of encoding a digital signal embodying the aforesaid twelfth aspect of the present invention.

A fifteenth aspect of the invention also relates to a computer program product that can be loaded into a programmable apparatus, comprising sequences of instructions for implementing a method of encoding a digital signal embodying the aforesaid twelfth aspect of the present invention, when the program is loaded into and executed by the programmable apparatus.

A sixteenth aspect of the invention further relates to a signal comprising information representative of filters for filtering a digital signal, which filters are determined by: dividing samples of the digital signal into at least two subsets of samples, the subsets corresponding respectively to different spatial grids that are arranged so that at least some samples of one said subset are interleaved spatially with at least some samples of another said subset, and by determining, for each said subset of samples, an optimal context function associated with the subset of samples concerned according to a first criterion, a context function being a function that, for a given sample, takes into account a predetermined number of other samples and outputs a context value amongst a predetermined number of context values, and a filter to be applied to a sample of the digital signal being determined as a function of the value of the optimal context function for said sample, wherein items of information representative of the determined filters are grouped into side information sub-signals as a function of the corresponding optimal context function and the grid, and each side information sub-signal is encoded.

A seventeenth aspect of the invention provides a side information signal which is useful to a decoder. The side information signal may be supplied to the decoder in a number of ways. Preferably, the side information signal is supplied to the decoder in the same way as the output encoded signal. For example, the output encoded signal and the side information signal may be supplied to the decoder via a network. Alternatively, the two signals may be stored on a recording medium such as a DVD or other storage medium.

The side information signal may be combined with the output encoded signal to produce a combined encoded signal. This combined encoded signal may then be transmitted via a network or stored on a recording medium. The recording medium may be a portable recording medium. Thus, an eighteenth of the present invention also provides a carrier medium carrying a side information signal embodying the invention or carrying such a combined encoded signal. The carrier medium may be a recording medium or a storage medium.

The particular characteristics and advantages of the storage means, of the computer program product and of the side information signal being similar to those of the method for encoding information representative of filters for filtering a digital signal, they are not repeated here.

A computer program or signal, as used herein, may be in transitory or non-transitory form, unless expressly indicated otherwise.

Other features and advantages will appear in the following description, which is given solely by way of non-limiting example and made with reference to the accompanying drawings, in which:

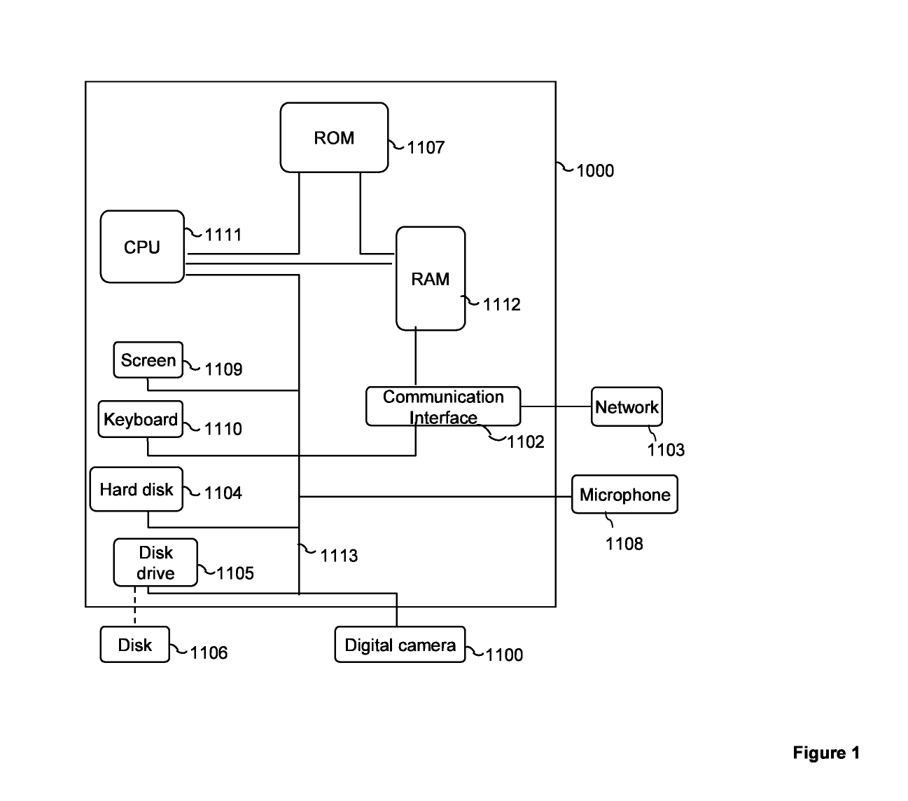

FIG. 1 is a diagram of a processing device adapted to implement the present invention;

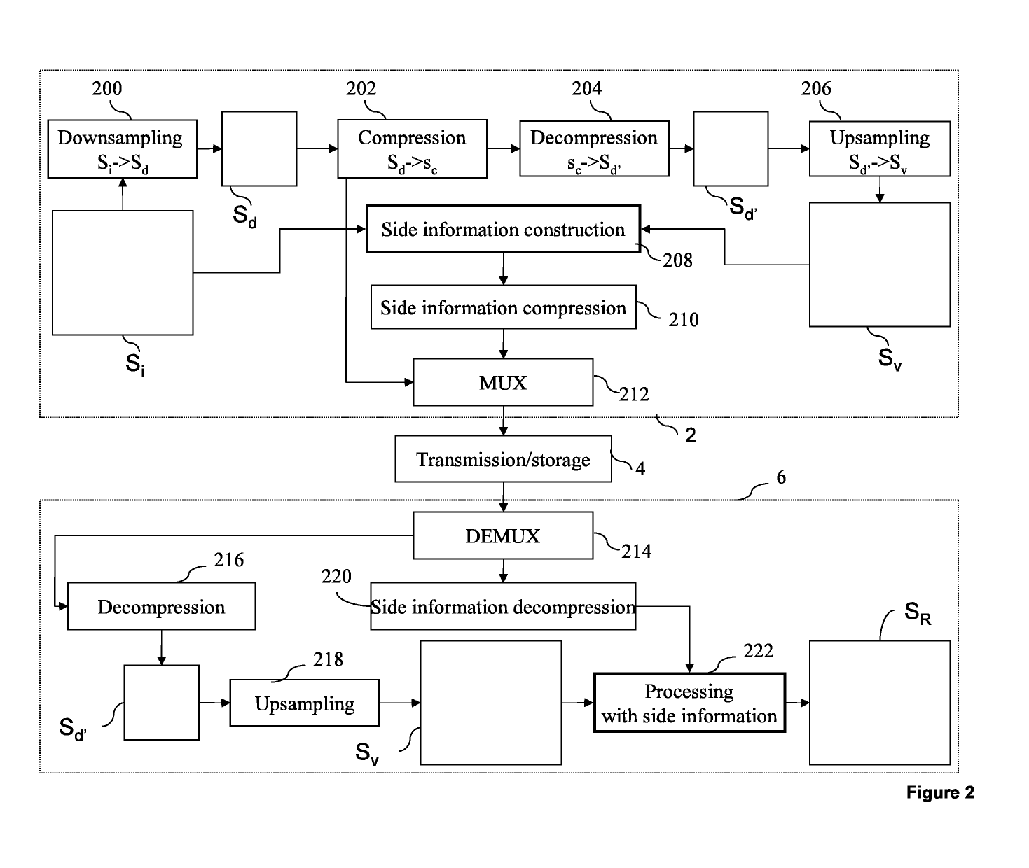

FIG. 2 illustrates a system for processing a digital signal in which the invention is implemented;

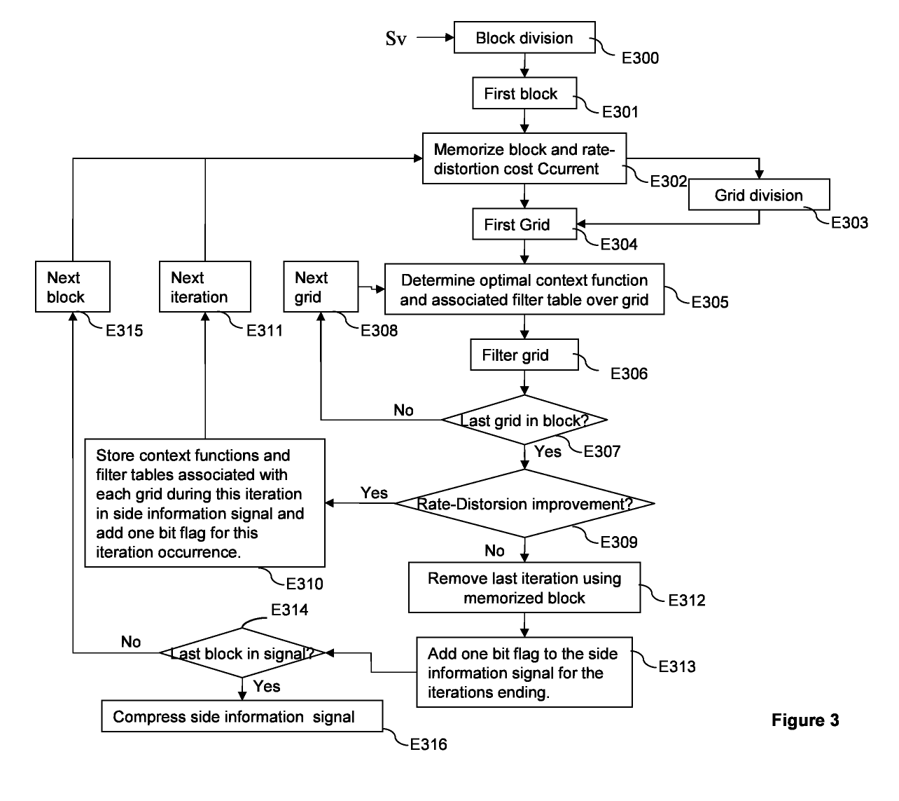

FIG. 3 illustrates the main steps of an encoding method and a side information construction method according to an embodiment of the invention;

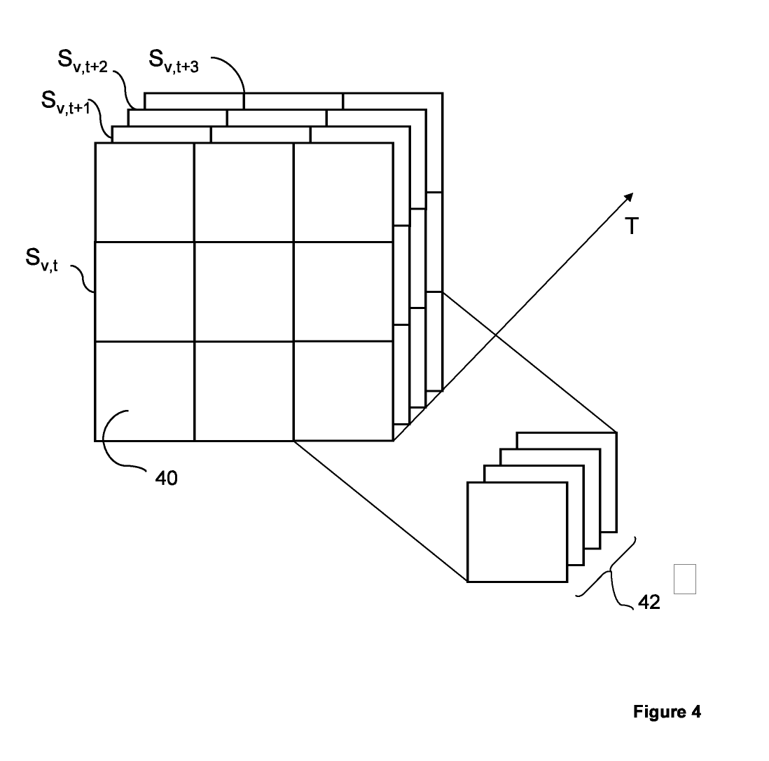

FIG. 4 illustrates a block division in the case of a digital video signal;

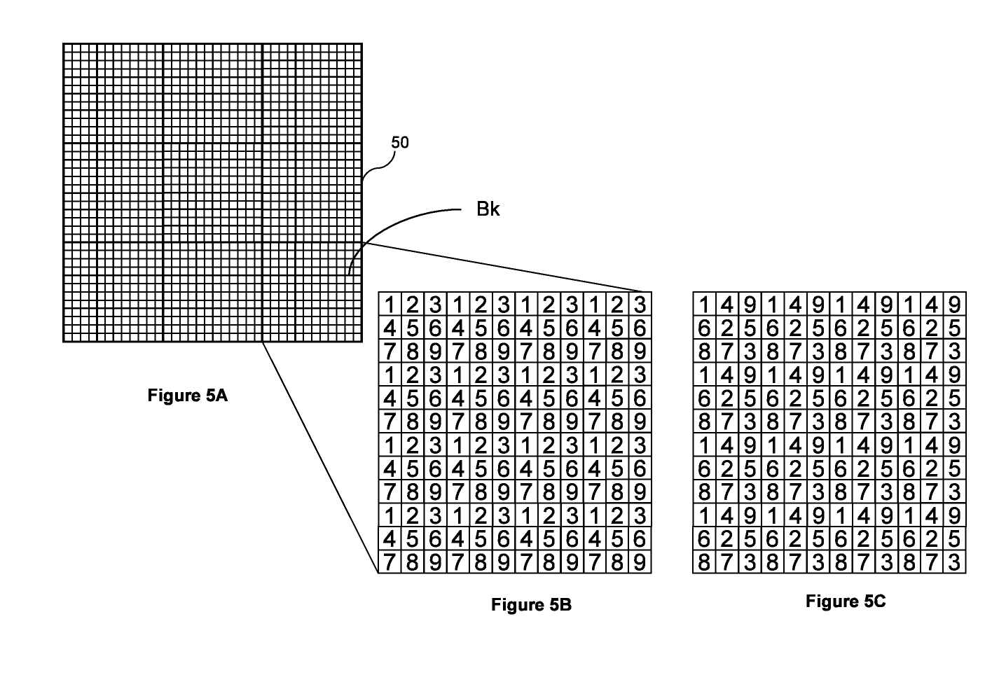

FIGS. 5A, 5B and 5C show examples of grid divisions;

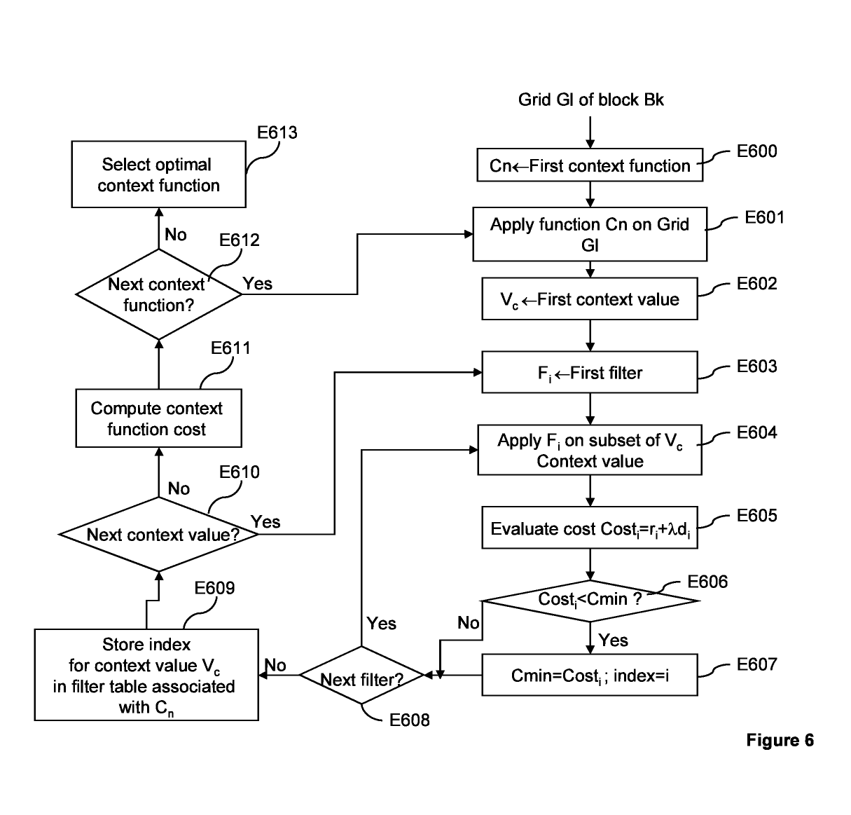

FIG. 6 illustrates the main steps of a method for determining an optimal context function and an associated filter table according to an embodiment of the invention;

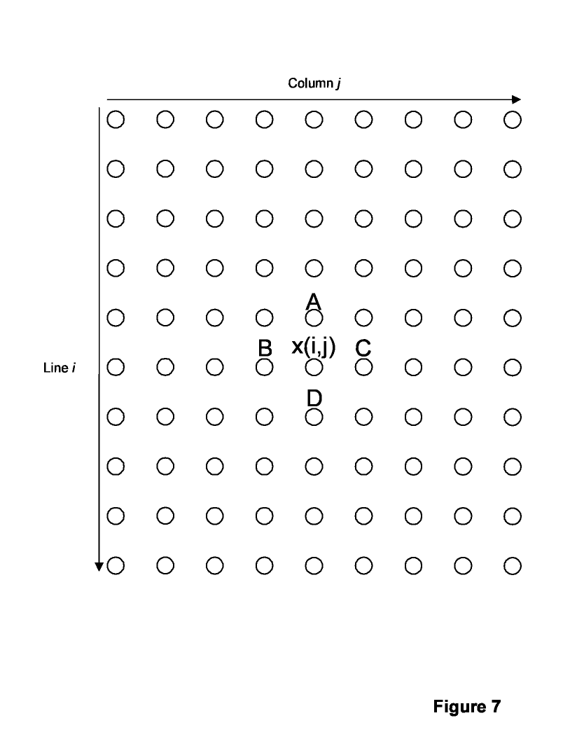

FIG. 7 illustrates an example of context function support;

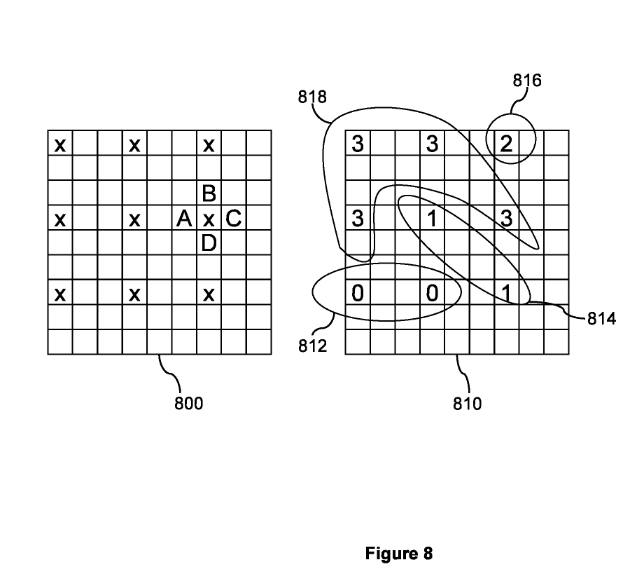

FIG. 8 illustrates the division of a set of samples into sub-signals according to a context function values;

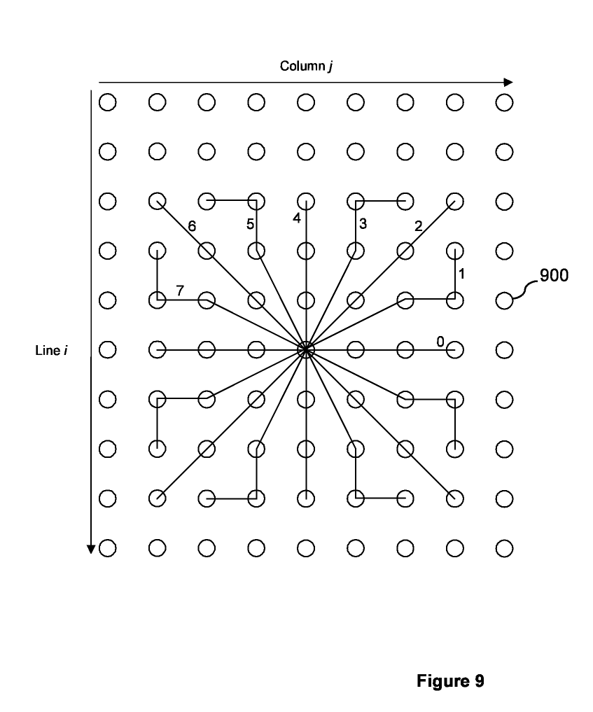

FIG. 9 illustrates an example of filtering according to eight predefined geometric orientations;

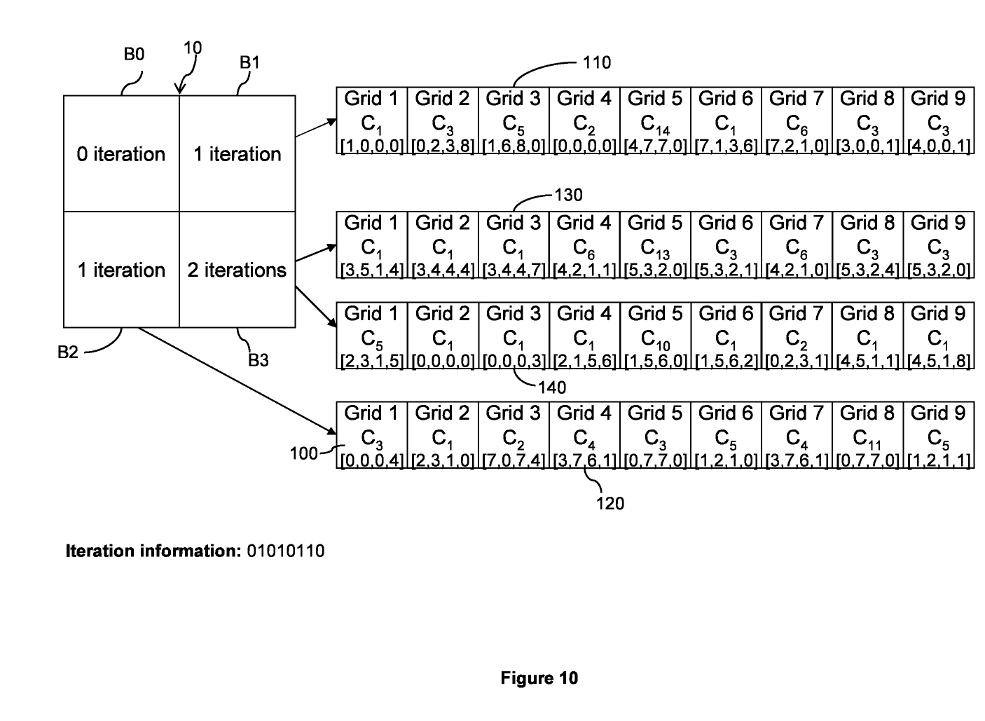

FIG. 10 illustrates the contents of the side information signal built for a set of blocks according to an embodiment;

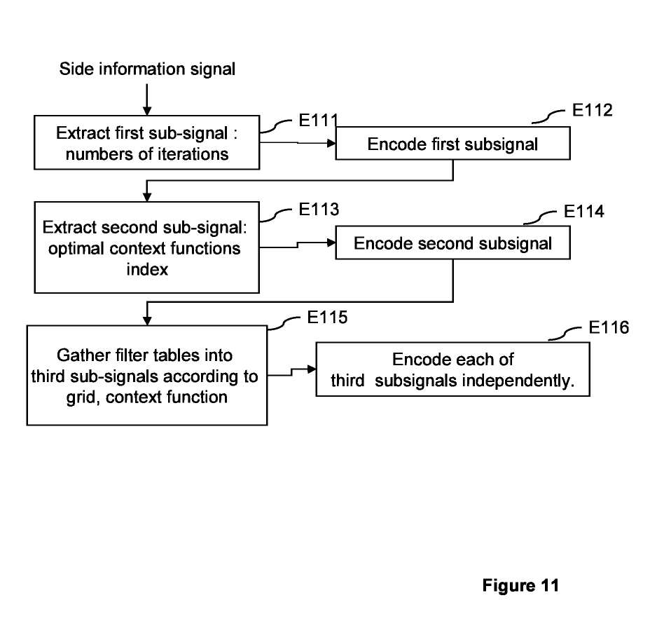

FIG. 11 illustrates the main steps of a method for compressing the side information signal according to the invention, and

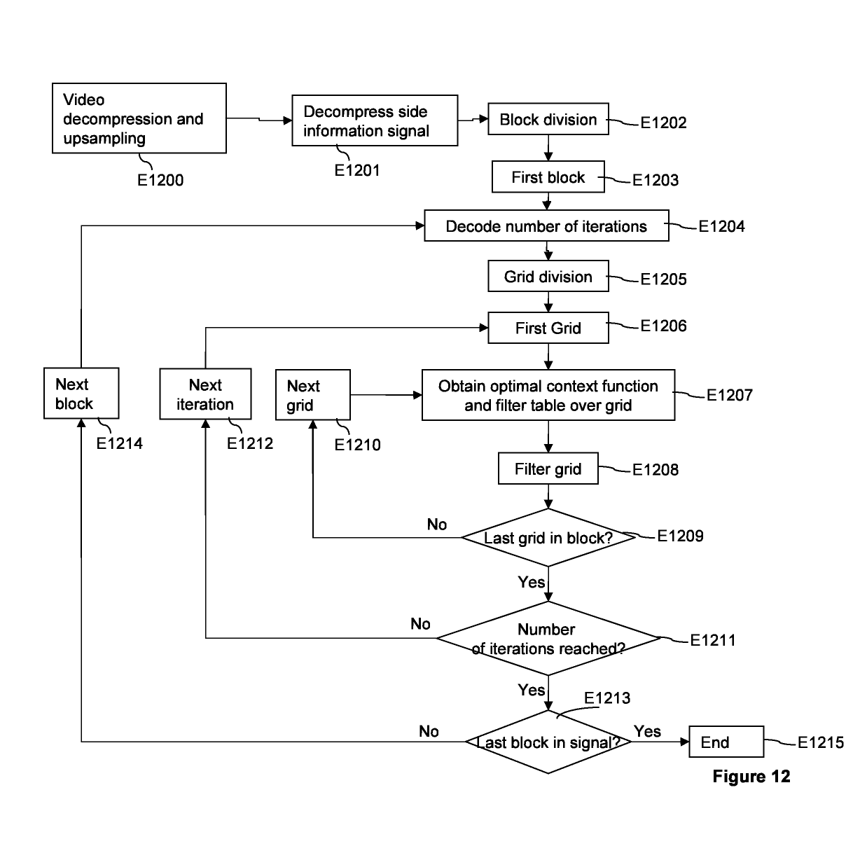

FIG. 12 illustrates the main steps of a decoding/upsampling method according to the invention.

FIG. 1 illustrates a diagram of a processing device 1000 adapted to implement the present invention. The apparatus 1000 is for example a micro-computer, a workstation or a light portable device.

The apparatus 1000 comprises a communication bus 1113 to which there are preferably connected:
a central processing unit 1111, such as a microprocessor, denoted CPU;
a read only memory 1107 able to contain computer programs for implementing the invention, denoted ROM;
a random access memory 1112, denoted RAM, able to contain the executable code of the method of the invention as well as the registers adapted to record variables and parameters necessary for implementing the invention; and
a communication interface 1102 connected to a communication network 1103 over which digital data to be processed are transmitted.

Optionally, the apparatus 1000 may also have the following components:
a data storage means 1104 such as a hard disk, able to contain the programs implementing the invention and data used or produced during the implementation of the invention;
a disk drive 1105 for a disk 1106, the disk drive being adapted to read data from the disk 1106 or to write data onto said disk;
a screen 1109 for displaying data and/or serving as a graphical interface with the user, by means of a keyboard 1110 or any other pointing means.

The apparatus 1000 can be connected to various peripherals, such as for example a digital camera 1100 or a microphone 1108, each being connected to an input/output card (not shown) so as to supply multimedia data to the apparatus 1000.

The communication bus affords communication and interoperability between the various elements included in the apparatus 1000 or connected to it. The representation of the bus is not limiting and in particular the central processing unit is able to communicate instructions to any element of the apparatus 1000 directly or by means of another element of the apparatus 1000.

The disk 1106 can be replaced by any information medium such as for example a compact disk (CD-ROM), rewritable or not, a ZIP disk or a memory card and, in general terms, by an information storage means that can be read by a microcomputer or by a microprocessor, integrated or not into the apparatus, possibly removable and adapted to store one or more programs whose execution enables the method of decoding a video sequence according to the invention to be implemented.

The executable code enabling the apparatus to implement the invention may be stored either in read only memory 1107, on the hard disk 1104 or on a removable digital medium such as for example a disk 1106 as described previously. According to a variant, the executable code of the programs can be received by means of the communication network, via the interface 1102, in order to be stored in one of the storage means of the apparatus 1000 before being executed, such as the hard disk 1104.

The central processing unit 1111 is adapted to control and direct the execution of the instructions or portions of software code of the program or programs according to the invention, instructions that are stored in one of the aforementioned storage means. On powering up, the program or programs that are stored in a non-volatile memory, for example on the hard disk 1104 or in the read only memory 1107, are transferred into the random access memory 1112, which then contains the executable code of the program or programs according to the invention, as well as registers for storing the variables and parameters necessary for implementing the invention.

In this embodiment, the apparatus is a programmable apparatus which uses software to implement the invention. However, alternatively, the present invention may be implemented in hardware (Application Specific Integrated Circuit or ASIC).

FIG. 2 illustrates a system for processing digital image signals (e.g. digital images or videos), comprising a coding device 2, a transmission or storage unit 4 and a decoding device 6.

Both the coding device and the decoding device are processing devices 1000 as described with respect to FIG. 1.

An original digital signal Sᵢ, having a high initial spatial resolution, is input at the encoder. In practice, such a high resolution signal is too large for convenient transmission over a network or even for local storage. For example, the original digital image signal may be a video comprising a number of frames of 1920×1080 pixels (width and height), commonly referred to as 1080 p format.

The invention advantageously allows the processing of the original high resolution signal providing additional information or side information which is adapted to reconstruct the high resolution image with a good visual quality at the decoder side.

In the system illustrated in FIG. 2, the original signal Sᵢ is downsampled to a signal S_{d} by a downsampling unit 200. The downsampling unit may implement any appropriate downsampling method as for example the conventional Lanczos filtering. For example, the video signal in 1080 p format could be downsampled to the resolution 1280×720 pixels, commonly referred to as 720 p format.

Optionally, in order to further enhance the compression, the signal S_{d} may be compressed by a compression unit 202 according to an adapted compression format (e.g. H264, SVC or MPEG-2 for video data). Next, the compressed signal s_{c} is decompressed by a decompression unit 204 to decompressed signal S_{d′}. In this way, the encoder reconstructs the data available at the decoder in the case a compression is applied to the digital signal to be transmitted and/or stored.

The downsampled signal S_{d} and, a fortiori, the downsampled and compressed signal s_{c} have a lower bitrate than the original digital signal Sᵢ.

The signal S_{d′}, is then upsampled using an upsampling unit 206, to the initial spatial resolution of the original signal Si. The upsampling unit 206 preferably implements the same upsampling process as at the decoder side. Preferably, the upsampling technique is matched to the one used during the downsampling stage.

The upsampled signal Sᵥ, also referred to as source signal, and the original signal Sᵢ are then used in a side information construction unit 208. The side information is generated in such a way that when it is combined with Sᵥ according to the invention, it optimizes the visual quality of the resulting signal while maintaining a low bitrate.

Next, the side information signal is further compressed by the side information compression unit 210.

Finally the downsampled and possibly compressed signal s_{c}, also referred to as the output encoded signal, is combined with the compressed side information signal by a multiplexing unit 212, to finally produce an encoded signal to be stored and/or transmitted by transmission/storage unit 4.

In a typical application scenario, the encoded signal is transmitted to a client device through a telecommunications network 1103, using an appropriate network transmission protocol.

At the client side, the decoding device receives the encoded signal, which is first processed by the de-multiplexing unit 214, which separates the compressed digital signal received s_{c} and the compressed side information signal.

The compressed digital signal is decompressed by unit 216 to form a reconstructed signal S_{d}, which is next upsampled to the resolution of the initial signal Sᵢ by the upsampling unit 218 into the upsampled image signal Sᵥ.

The compressed side information signal is transmitted to a side information decompression unit 220.

Finally, the upsampled reconstructed signal Sᵥ and the decompressed side information signal are processed together by the processing unit 222. The resulting image signal S_{R} has the same resolution as the original digital image signal, and an improved visual quality as compared to upsampled reconstructed signal Sᵥ.

The flow diagram in FIG. 3 illustrates the main steps of an encoding method and side information signal construction, that are used during the encoding of a digital signal, in a particular embodiment where the signal is a digital video signal.

All the steps of the algorithm represented in FIG. 3 can be implemented in software and executed by the central processing unit 1111 of the device 1000.

The samples of a digital image/video signal are commonly known as pixels.

The algorithm illustrated in FIG. 3 takes as input an original video signal Sᵢ having a given resolution, for example 1920×1080 pixels, and a corresponding source video signal Sᵥ, of the same resolution, obtained by downsampling, compression/decompression and upsampling as explained above with reference to FIG. 2.

The downsampling/upsampling factors in the vertical and horizontal direction are external parameters, for example provided by a user. For example, if the original video signal has a resolution of 1920×1080 pixels and the downsampled video signal to be transmitted/stored has a resolution of 1280×720 pixels, the downsampling factor is 1.5 in each direction.

In a block division step E300, the source signal Sᵥ is divided into blocks. In the preferred embodiment, each frame of the video is divided into square blocks of W×W pixels. In the example of FIG. 5, W=12.

FIG. 4 illustrates an example of block division in the case of a video signal, as implemented in the preferred embodiment. The concept of square blocks is extended to a third dimension, which is the temporal dimension. A video signal is divided into three dimensional blocks (or cubes) of W×W×D pixels. In the example of FIG. 5, D=4. A set of 4 successive video frames S_{v,t} to S_{v,t+3} are considered, each of them being divided into square blocks 40 of W×W pixels. The video is thus partitioned into cubes 42 which will be successively processed in a predefined order. In the subsequent description, the term block will be used to designate both two dimensional blocks in the case of a digital image signal processing and three dimensional blocks in the case of video signal processing.

Back to FIG. 3, step E300 is followed by step E301 where the first block of source signal Sᵥ is considered as a current block Bk to be processed.

At the following step E302, the values of the pixels constituting the block are stored in memory, for example in an appropriate register of the RAM 1112. The memorized block is designated as MBk. Further, a rate-distortion cost Ccurrent associated with the block MBk is also stored in memory.

Typically, a rate-distortion cost is calculated as: Ccurrent=Rₖ+λ Dₖ, where Rₖ designates the rate, Dₖ designates the distortion and λ is a predetermined parameter, for example input by the user.

The distortion is evaluated between block MBk and a block OBk of the original digital signal Si, which is located at the same position as block Bk.

Initially, MBk is a block from the source digital signal Sᵥ, the rate Rₖ is equal to 1, since just one bit is necessary to encode a single iteration and the distortion Dₖ is equal to the square error between Bk and OBk.

Next, the current block Bk is divided into spatial grids in a grid division step E303. A grid is a subset of pixels of the block, at least part of the samples of a grid being interleaved with at least part of the samples of another grid. In the preferred embodiment, the grids are regularly spaced, the subsets of samples of a grid being regularly distributed along the horizontal and the vertical axis. Alternatively, the grid might be placed in staggered rows.

FIG. 5 shows several examples of grid division. The grids are arranged so that at least some samples of one subset corresponding to a grid are interleaved spatially with at least some samples of another said subset corresponding to another grid.

FIG. 5A represents an image frame 50 which is divided into blocks of 12×12 pixels. FIGS. 5B and 5C show examples of grid divisions of a block Bk of FIG. 5A.

In the representation of FIGS. 5B and 5C, the pixels are labeled with the index of the grid they belong to. The 12×12 block Bk is divided into 9 spatial groups or grids. In both figures, the grids are composed of signal samples (pixels) which are separated by two samples in both horizontal and vertical directions. The grid index defines an order of subsequent processing of the signal samples.

FIG. 5B shows a first example of grid division, in which the grids are labeled following the lexicographic order.

FIG. 5C shows an alternative example of grid division, with the same number of grids per block.

In the preferred embodiment, the spacing between the samples of a grid is chosen based on the length of filters to be applied.

In the case of video signal processing, when a block Bk is actually extended also in the time dimension, the grids defined above are applied for each of the successive frames, so as to form a three dimensional grid within a cube.

At the following step E304 the first grid of the current block Bk is considered as current grid GI.

The current grid is processed at step E305 to determine an optimal context function and the associated filter table when applying a set of predetermined filters.

An implementation of step E305 is described in detail with respect to the flowchart of FIG. 6. All the steps of the algorithm represented in FIG. 6 can be implemented in software and executed by the central processing unit 1111 of the device 1000.

The aim of the processing is to select and designate, for each pixel of the current grid, a filter amongst a predetermined set of filters, so as to satisfy a first criterion which is, in this embodiment, minimizing a cost criterion when applying the selected filters to the digital samples belonging to the grid. In this embodiment, the cost criterion is a distortion-rate cost, the distortion being calculated between the filtered digital signal and the original signal Sᵢ.

The filters may be selected according to the local characteristics of the digital signal Sᵥ being processed. Such local characteristics are captured using a set of predetermined context functions, which represent local variations in the neighborhood of a sample when applied to the sample.

In the preferred embodiment, a set of context functions can be defined for a given sample x(i,j) situated on the i^{th} line and the j^{th} column, as a function of the values of the neighbouring sample A, B, C, D which are respectively situated at spatial position (i−1,j), (j−1,i), (i, j+1), (i+1,j), as illustrated in FIG. 7.

In order to have a relatively simple representation, all context functions used return a value amongst a predetermined set of values, called the context values.

For example, the following set of 16 context functions C₀ to C₁₅ may be used:

C₀(x(i,j))=0 if A≦B and A≦C
1 if A≦B and A>C
2 if A>B and A≦C
3 if A>B and A>C
   C₁(x(i,j))=0 if A≦B and A≦D
1 if A≦B and A>D
2 if A>B and A≦D
3 if A>B and A>D
   C₂(x(i,j))=0 if A≦B and A≦D
1 if A≦B and B>C
2 if A>B and A≦D
3 if A>B and B>C
   C₃(x(i,j))=0 if A≦B and C≦D
1 if A≦B and B>D
2 if A>B and B≦D
3 if A>B and B>D
   C₄(x(i,j))=0 if A≦B and C≦D
1 if A≦B and C>D
2 if A≦B and C≦D
3 if A>B and C>D
   C₅(x(i,j))=0 if A≦C and A≦D
1 if A≦C and A>D
2 if A>C and A≦D
3 if A>C and A>D
   C₆(x(i,j))=0 if A≦C and B≦C
1 if A≦C and B>C
2 if A>C and B≦C
3 if A>C and B>C
   C₇(x(i,j))=0 if A≦C and B≦D
1 if A≦C and B>D
2 if A>C and B≦D
3 if A>C and B>D
   C₈(x(i,j))=0 if A≦C and C≦D
1 if A≦C and C>D
2 if A>C and C≦D
3 if A>C and C>D
   C₉(x(i,j))=0 if A≦D and B≦C
1 if A≦D and B>C
2 if A>D and B≦C
3 if A>D and B>D
   C₁₀(x(i,j))=0 if A≦D and B≦D
1 if A≦D and B>D
2 if A>D and B≦D
3 if A>D and B>D
   C₁₁(x(i,j))=0 if A≦D and C≦D
1 if A≦D and C>D
2 if A>D and C≦D
3 if A>D and C>D
   C₁₂(x(i,j))=0 if B≦C and B≦D
1 if B≦C and B>D
2 if B>C and B≦D
3 if B>C and C>D
   C₁₃(x(i,j))=0 if B≦C and C≦D
1 if B≦C and C>D
2 if B>C and C≦D
3 if B>C and C>D
   C₁₄(x(i,j))=0 if B≦D and C≦D
1 if B≦D and C>D
2 if B>D and C≦D
3 if B>D and C>D
   C₁₅(x(i,j))=0 if B≦x(i,j) and C≦D
1 if B≦x(i,j) and C>D
2 if B>x(i,j) and C≦D
3 if B>x(i,j) and C>D

All context functions of this example may take only four context values amongst the set {0, 1, 2, 3}.

The algorithm of FIG. 6 takes as an input a digital signal composed of the samples of the current grid (GI) of the current block Bk of the source signal.

In the first step E600, the first context function amongst the set of context functions to be tested is selected as the current context function Cn.

At step E601 the context function Cn is applied to all digital samples of the current grid, using the values of the digital samples A, B, C, D of the neighborhood as explained above to obtain a context value for each sample of the grid. All the samples to be processed, i.e. all the samples belonging to grid GI, are represented with a cross on the block 800 represented on FIG. 8.

Each sample of the grid has an associated context value using context function Cn, as illustrated in block 810 of FIG. 8. The subset of samples forming current grid GI is further partitioned into subsets of samples having the same context value. On FIG. 8 we distinguish: subset 812 of samples having a context value equal to 0, subset 814 of samples having a context value equal to 1, subset 816 of samples having a context value equal to 2 and subset 818 of samples having a context value equal to 3.

The method according to the invention is adapted to determine an optimal filter among a predetermined set of filters for each subset of samples having the same context value.

In the preferred embodiment, the set of filters is composed of 8 oriented filters, illustrated schematically in FIG. 9. The digital sample to be filtered is pixel x(i,j) situated on the i^{th} line and the j^{th} column. The lines labeled 0 to 7 in the figure correspond to the supports of the filters F₀ to F₇, that is to say the set of pixels used in the linear filtering operation.

For example, the filters F₀ to F₇ may be defined as:

F₀=a·x(i,j)+b·(x(i,j+1)+x(i,j−1))+c·(x(i,j+2)+x(i,j−2))+d·(x(i,j+3)+x(i,j−3))

F₁=a·x(i,j)+b·(x(i−1,j+2)+x(i+1,j−2))+c·(x(i−1,j+3)+x(i+1,j−3))+d·(x(i−2,j+3)+x(i+2,j−3))

F₂=a·x(i,j)+b·(x(i+1,j+1)+x(i−1,j−1))+c·(x(i+2,j+2)+x(i−2,j−2))+d·(x(i+3,j+3)+x(i−3,j−3))

F₃=a·x(i,j)+b·(x(i+2,j−1)+x(i−2,j+1))+c·(x(i+3,j−1)+x(i−3,j+1))+d·(x(i+3,j−2)+x(i−3,j+2))

F₄=a·x(i,j)+b·(x(i+1,j)+x(i−1,j))+c·(x(i+2,j)+x(i−2,j))+d·(x(i+3,j)+x(i−3,j))

F₅=a·x(i,j)+b·(x(i+2,j+1)+x(i−2,j−1))+c·(x(i+3,j+1)+x(i−3,j−1))+d·(x(i+3,j+2)+x(i−3,j−2))

F₆=a·x(i,j)+b·(x(i−1,j+1)+x(i+1,j−1))+c·(x(i−2,j+2)+x(i+2,j−2))+d·(x(i−3,j+3)+x(i+3,j−3))

F₇=a·x(i,j)+b·(x(i−1,j−2)+x(i+1,j+2))+c·(x(i−1,j−3)+x(i+1,j+3))+d·(x(i−2,j−3)+x(i+2,j+3))

where a,b,c,d have predefined values for all filters of the set.

In an alternative embodiment, a,b,c,d may take different values for different filters.

It is advantageous to use such oriented filters because they are adapted to filter accurately local areas containing oriented edges.

Back to FIG. 6, step E601 is followed by step E602, in which the first context value is taken as the current context value V_{c}.

Next the first filter of the set of filters is taken as the current filter Fᵢ (step E603), and is applied to all digital samples of the subset of samples having a context value equal to V_{c} at step E604.

A rate-distortion cost associated to filter Fᵢ of the subset of samples of context value V_{c} of context function Cn is then calculated at step E605, according to the formula: Costᵢ=rᵢ+λdᵢ, where rᵢ designates the rate of filter Fᵢ, λ is a parameter determined by the user and dᵢ is a distortion between the subset of filtered samples being processed and the corresponding samples of the original digital signal Sᵢ.

In the preferred embodiment, each filter has a predetermined associated rate rᵢ. The rate values are estimated over a set of reference video sequences before encoding and decoding. In an alternative embodiment, each filter might have a plurality of associated rates, each rate being estimated from the set of reference video sequences for a given combination of grid and context function. The rate value or values associated to each filter are input parameters of the algorithm, that are stored in a table for example.

The value of the parameter λ represents the balance between the amount of rate dedicated to the side information and the upsampling quality. For example, λ may take one of the following values [0.005, 0.02, 0.03].

The distortion dᵢ is simply computed as the square error between the values of the filtered samples and the corresponding values of the original samples, i.e. the original samples at the spatially location as the filtered samples.

The rate-distortion cost value Costᵢ calculated is then compared to a value Cmin at step E606.

If Costᵢ is lower than Cmin (test E606) or if the current filter is the first filter of the filter set (i=0), Cmin is set equal to Costᵢ and a variable index is set equal to i at step E607. The variable index stores the index of the best filter F, i.e. the filter whose application results in the lowest rate-distortion cost.

If the outcome of the test E606 is negative or after step E607, the test E608 verifies if there is a remaining filter to evaluate.

In case there is a remaining filter, i.e. using the filter set above, if the index of the current filter is lower than 7, steps E604 to E607 are applied again.

If all the filters have been evaluated, step E608 is followed by step E609 at which the value of the index variable is stored for the current value V_{c} of the context function. For example, the index value is stored in a table called filter table, associated with the context function Cn for the processed grid GI.

It is next checked at step E610 if there is a remaining context value to be processed, i.e. using the set of possible context values in the example above, if the current context value V_{c} is less than 3. In case there are more context values to be processed, the next context value is taken as the current context value and the processing returns to step E603.

If, on the contrary, all the context values have been processed, it means that the filter table associated with the context function Cn for the processed grid GI is complete. Using the example above, since each context function may take only four values 0, 1, 2 and 3, a filter table is simply a list of four filter indexes. An example of filter table is T(Bk,GI,Cn)=[4,0,1,1]. A sample x(i,j) of grid GI of block Bk should be filtered with: F₄ if the context function takes value 0 on x(i,j), F₀ if the context function takes value 1 on x(i,j), F₁ if the context function takes value 2 on x(i,j) and F₁ if the context function takes value 3 on x(i,j).

The cost Costᵢ corresponding to each optimal filter for each subset is also stored in memory.

Next, it is possible to compute the cost of the context function Cn on the grid GI at step E611, as the sum of the cost Costᵢ of the four optimal filters for each subset. The rate of the description of the context function is also added. In the example, the rate of the description of each context function is 4 bits since there are 16 possible context functions. Alternatively, each context function might be attributed an adapted rate, depending on its statistics.

The cost value associated to the current context function Cn is stored in memory, along with the filter table associated with it.

Next it is checked if there are other context functions to process at step E612. In case of positive answer, the following context function is considered as the current context function, and the processing returns to step E601 where the current context function is applied to the grid GI.

If all the context functions have been processed, step E612 is followed by step E613 at which the optimal context function for the current grid is selected according to a second predefined criterion.

In the preferred embodiment, the context function Cₒₚₜ having the lowest cost is chosen as the optimal context function.

This optimal context function and the associated filter table constitute the output of step E305 of FIG. 3.

Back to FIG. 3, step E305 is followed by a filtering step E306 during which each sample x(i,j) of the current grid is filtered. First the context value of the optimal context function on the current sample x(i,j) is computed. The index of the filter to be applied is given by the filter table based on the context value of x(i,j).

As already pointed out with respect to FIG. 9, each filter extends across the grids, so a filtered sample value is obtained as a function of samples values of adjacent samples from different grids.

The following step E307 tests if the current grid is the last grid in the block, i.e. grid of index 9 in the example of FIG. 5B.

In case of negative answer, the next grid is considered at step E308 and the processing returns to step E305.

In case the answer to test E307 is positive, i.e. if the current grid processed is the last grid in the block, step E307 is followed by step E309 of verification of a third predefined criterion, which is, in this embodiment, the rate-distortion improvement.

Indeed, once all the grids of the current block have been filtered using the filters associated to an optimal context function per grid, it is possible to evaluate if the current iteration iter brings an improvement in terms of the rate-distortion compromise.

It is therefore necessary to determine the distortion and the rate of the current block after grid filtering.

The distortion Dₖ(iter) is computed, as already explained with respect to step E302, as the square error between the filtered digital signal of block Bk and the corresponding original signal OBk.

The rate Rₖ(iter) depends on the selection of the optimal context function and associated filter table made for each grid in the current block.

As explained above with respect to step E605, each filter Fi of the predetermined filter set has a predetermined associated rate rᵢ. The rate values are evaluated over a set of reference video sequences before encoding and decoding. In a particular embodiment, a different rate rᵢ(GI,Cn) is associated to every combination of grid index and context function.

For each grid GI, the rate RI corresponding to the grid GI is computed as the sum of the predetermined rates of the filters of the filter table used for the grid. The rate necessary to encode the context function is also added. It is equal to 4 bits to encode one context function out of 16.

The total rate Rₖ(iter) for the current iteration on block Bk is equal to the sum of the grid rates RI plus 1 bit for a flag indicating the fact that the iteration is applied, e.g. the bit “1”.

The total rate after the current iteration iter is equal to the rate dedicated to the current iteration added to the rate necessary to encode the previous iterations, R(previous). We note that R(previous) is equal to 0 when the current iteration is the first one.

Finally, the distortion rate cost corresponding to the current iteration is computed as: Cnew=Rₖ(iter)+R(previous)+λDₖ(iter).

The cost of applying the current iteration is compared to the cost of not applying the current iteration. The cost of not applying the current iteration is equal to the cost previously stored in memory, Ccurrent, plus 1 for a bit flag indicating that the current iteration is not applied, and subsequently the end of iterations. If Cnew is lower than (Ccurrent+1), it means that the current iteration brings a rate-distortion improvement.

Then step E309 is followed by step E310, in which the optimal context function and the associated filter table determined for each grid of the current block Bk are added to the side information signal, as well as the bit flag indicating the application of the current iteration.

The processing passes then to the next iteration on the current block Bk at step E311.

Step E311 is followed by step E302 at which the values of the filtered digital samples of block Bk are stored in the memorized block MBk. The rate-distortion cost Cnew calculated at step E309 is also stored as cost Ccurrent of the previous iteration.

Back to step E309, if the current iteration does not bring a rate-distortion improvement, i.e. if the cost Cnew is higher than the cost (Ccurrent+1), then step E309 is followed by step E312 of removing last iteration.

At this step the values of the filtered samples of block Bk resulting from the last iteration are replaced by the values stored in the memorized block MBk. This is useful to avoid any distortion in the subsequent processing of the following blocks, since some filtered samples on the current block will be used to calculated the filtered samples of the next block which is spatially adjacent.

Finally, step E313 adds a bit flag to the side information signal, e.g. the bit “0”, to indicate that the iterative process stops when the last iteration does not bring any rate-distortion improvement. The set of all bit flags indicating the occurrence or non occurrence of an iteration forms a binary code of the number of iterations applied.

Next, it is checked whether the current block is the last block of signal Sᵥ to be processed at step E314. In case of negative answer, step E314 is followed by step E315, during which the next block to be processed is set as current block. In case of positive answer, step E314 is followed by step E316 of compression of the side information signal.

In a first simple embodiment, the side information signal is compressed using entropic coding, for example using arithmetic coding. The advantage of this simple embodiment is a low computational complexity.

An alternative embodiment, achieving a higher rate of compression of the side information signal is now described in relation with FIGS. 10 and 11.

FIG. 10 shows a digital signal 10 divided into four blocks, referenced B0, B1, B2 and B3. The number of iterations to be applied to each block is respectively 0, 1, 1 and 2. The side information signal for each block having at least one associated iteration is schematically represented on the figure by the signal 110 for block B1, 120 for block B2 and the two signals 130 and 140 for block B3, respectively corresponding to the two iterations.

Each side information signal is represented as a concatenation of cells 100, each cell containing a grid index, an associated optimal context function found according to the method of the invention and the associated filter table represented as [u₀, u₁, u₂, u₃].

We note that if no particular processing is applied, the side information signal is composed as a concatenation of the sub-signals taken for example in the increasing order of blocks, and in the increasing order of iterations per block. In practice in this example the side information signal would be constituted of 110, 120, 130 and 140. The side information signal contains for each block, the binary code encoding the number of iterations, and for each iteration, for each grid, the index of the optimal context function and the associated filter table.

In order to achieve a higher compression rate of the side information signal, the side information signal is divided into sub-signals.

FIG. 11 represents a flowchart of an embodiment of a method of compression of the side information signal. All the steps of the algorithm represented in FIG. 11 can be implemented in software and executed by the central processing unit 1111 of the device 1000.

Firstly, at step E111, the codes encoding the number of iterations for each block is extracted to form a first side information sub-signal, which is coded independently at step E112, using known means, either coding on a fixed number of bits or an entropic coding such as Huffman coding or arithmetic coding. In the example of FIG. 10, the first side information sub-signal corresponding to the numbers of iterations is {0,1,1,2}.

Next, at step E113, the signal representing the index of the optimal context function per grid is extracted to form a second side information sub-signal.

This second side information sub-signal is coded separately during step E114, using an adapted entropy encoder, such as Huffman encoding or arithmetic encoding. In the example of FIG. 10, the second side information sub-signal, formed in the increasing order of the blocks, is the following: {1,3,5,2,14,1,6,3,3,3,1,2,4,3,5,4,11,5,1,1,1,6,13,3,6,3,3,5,1,1,1,10,1,2,1,1}

Finally, during step E115, the filter tables are gathered together into several third side information sub-signals, according to the grid and context function they are associated with.

In the example of FIG. 10, the following set of third side information sub-signals can be extracted:

Grid 1, context function C1: {[1,0,0,0],[3,5,1,4]};
Grid 1, context function C3: {[0,0,0,4]};
Grid 1, context function C5: {[2,3,1,5]};
Grid 2, context function C1: {[2,3,1,0],[3,4,4,4],[0,0,0,0]};
Grid 2, context function C3: {[0,2,3,8]};
Grid 3, context function C1: {[3,4,4,7],0,0,0,3]}
Grid 3, context function C2: {[7,0,7,4]};
Grid 3, context function C5: {[1,6,8,0]};
Grid 4, context function C1: {[2,1,5,6]};
Grid 4, context function C2: {[0,0,0,0]};
Grid 4, context function C4: {[3,7,6,1]};
Grid 4, context function C6: {[4,2,1,1]};
Grid 5, context function C3: {[0,7,7,0]};
Grid 5, context function C10: {[1,5,6,0]};
Grid 5, context function C13: {[5,3,2,0]};
Grid 5, context function C14: {[4,7,7,0]};
Grid 6, context function C1: {[7,1,3,6],[1,5,6,2]};
Grid 6, context function C3: {[5,3,2,1]};
Grid 6, context function C5: {[1,2,1,0]};
Grid 7, context function C2: {[0,2,3,1]};
Grid 7, context function C4: {[3,7,6,1]};
Grid 7, context function C6: {[7,2,1,0],[4,2,1,0]};
Grid 8, context function C1: {[4,5,1,1]};
Grid 8, context function C3: {[3,0,0,1],[5,3,2,4]};
Grid 8, context function C11: {[0,7,7,0]};
Grid 9, context function C1: {[4,5,1,8]};
Grid 9, context function C3: {[4,0,0,1],[5,3,2,0]};
Grid 9, context function C5: {[1,2,1,1]};

Using 9 grids and 16 possible context functions, the maximum number of third side information sub-signals to encode is equal to 144.

In the preferred embodiment, each third side information sub-signal is next encoded at an encoding step E116 with an adapted entropy coder, according to its statistics. For example, an adapted entropic or arithmetic encoder can be designed for each third side information sub-signal.

This is advantageous since it was shown experimentally that the sub-signal contains filter table information related to a particular grid number and context function have similar statistics, and consequently designing specific entropy encoder for such signals is likely to be efficient.

Alternatively, some of the third side information sub-signals could be considered similar in their statistics, in which case they could be encoded using a same entropy encoder, for example the same dictionary in Huffman coding.

The flow diagram in FIG. 12 illustrates steps of a decoding/upsampling method using the side information signal generated according to the present invention, in a particular embodiment where the signal is a digital video signal.

All the steps of the algorithm represented in FIG. 12 can be implemented in software and executed by the central processing unit 1111 of the device 1000.

The bitstream of the encoded video signal, comprising the compressed digital video signal s_{c} and the compressed side information signal, is either received through the communication network 1103 or retrieved from a storage memory space. Firstly, the encoded video signal bitstream is separated into the compressed digital video signal s_{c} and the compressed side information signal by demultiplexing unit 214 as explained with respect to FIG. 2.

The compressed digital video signal is decompressed and upsampled in a first step E1200. The compression being optional, the received/retrieved signal might be uniquely up-sampled during step E1200, to a target resolution R. A digital video signal S_{v′} is obtained.

The target resolution can be pre-defined, as for example the resolution 1920×1080 pixels for the format 1080 p. Alternatively, the target resolution might be written in the bitstream.

The side information signal is also decompressed during step E1201. The reverse process of the one described with respect to FIG. 11 is applied. Each sub-signal is decoded using the appropriate decoder, and next the sub-signals are combined. The final decompressed side-information signal contains, for each block, information on the number of iterations, and for each iteration, for each grid amongst the set of predetermined grids, an information (typically an index) representing the optimal context function and the associated filter table.

Next, at step E1202, the digital video signal is divided into blocks, in an analogous manner to step E300 at the encoder. The first block is considered as the current block Bk at step E1203.

The number of iterations required for the current block Bk is read from the side information signal during following step E1204.

The current block being processed Bk is then divided into grids at step E1205, in an analogous manner to the grid division performed during step E303 at the encoder. The first grid is selected as the current gird at step E1206.

Step E1206 is followed by step E1207 of obtaining the index of the optimal context function determined for the current grid and the associated filter table from the side information signal.

The digital samples of the current grid are then filtered at step E1208. This filtering is analogous to the filtering step E306 carried out at the encoder. First the context value of the optimal context function on each sample x(i,j) of the current grid is computed. The index of the filter to be applied is given by the filter table based on the context value of x(i,j).

After filtering all samples of the current grid, it is tested at step E1209 whether the current grid is the last grid of the current block.

In case of negative answer, test E1209 is followed by step E1210 during which the next grid is selected as current grid. The process returns then to step E1207.

In case of positive answer, test E1209 is followed by step E1211 checking if the number of iterations for the current block Bk has been reached. If the answer is negative, the process passes to the next iteration (step E1212). In practice, an iteration counter is increased by one. Step E1212 is followed by step E1206 already described, and the next iteration of the filtering for all the grids composing the current block is carried out.

If all the iterations for the current block Bk have been carried out, step E1211 is followed by step E1213 for checking whether the current block Bk is the last block in the signal. If there are more blocks to process (answer ‘no’ to the test E1213), step E1213 is followed by step E1214 of selection of the next block as the current block. Step E1214 is followed by step E1204 already described, in order to apply the whole processing to the current block.

If all the blocks have been processed, the decoding/upsampling process ends at step E1215.

The result of this processing is a decoded and upsampled signal which has a good visual quality.

1. A signal processing method, comprising the steps of:
receiving an output encoded signal obtained from an original digital signal having an initial spatial resolution and an initial bit rate, the output encoded signal having a bitrate lower than the initial bitrate,
processing the output encoded signal to obtain a source signal having the initial spatial resolution,
dividing samples of the source signal into at least two subsets of samples, the subsets corresponding respectively to different spatial grids that are arranged so that at least some samples of one subset are interleaved spatially with at least some samples of another said subset,
and, for each said subset:
determining, for at least one sample of the subset, at least one filter amongst a set of predetermined filters according to a first predetermined criterion,
inserting, in a side information signal, information representative of the filter(s) determined for the samples of the subset concerned.

2. A method according to claim 1, wherein the first predetermined criterion is a rate-distortion cost, a distortion being calculated between samples of the source signal and corresponding samples of the original digital signal.

3. A method according to claim 1, wherein the output encoded signal is obtained by down-sampling the original signal to a down-sampled signal (S_{d}) having a resolution lower than the initial resolution.

4. A method according to claim 3, wherein the source signal is obtained by up-sampling the down-sampled signal at the initial resolution.

5. A method according to claim 3, wherein the output encoded signal is obtained by compressing the down-sampled signal.

6. A method according to claim 5, wherein the step of obtaining a source signal further comprises decompressing the compressed down-sampled signal before up-sampling.

7. A method according to claim 1, comprising, before the step of dividing the samples of the source signal into subsets, a step of dividing the source signal into a plurality of blocks, and the subsequent steps are applied to each block of samples.

8. A method according to claim 1, wherein the step of determining at least one filter comprises:
determining an optimal context function amongst a plurality of context functions for the subset of samples to be processed, and a subset of filters associated to said optimal context function,
wherein a context function is a function that, for a given sample, takes into account a predetermined number of other samples and outputs a context value amongst a predetermined number of context values.

9. (canceled)

10. A method according to claim 8, wherein the step of determining an optimal context function comprises:
a step of determining a context function cost and a context function associated filter table for a context function of the plurality of context functions comprising:
calculating the value of the context function for each sample of the subset of samples to be processed;
dividing the samples of the subset to be processed into a set of sub-signals corresponding respectively to the various context values of said context functions;
and, for each sub-signal:
determining an optimal filter according to a second criterion that depends on the sample values of the sub-signal; and
memorizing said optimal filter associated with the context value taken by the context function on the sub-signal.

11. A method according to claim 10, wherein the second criterion consists in selecting the filter that minimizes a rate-distortion cost, a predetermined rate being associated to each filter and a distortion being computed between filtered samples of the sub-signal and corresponding samples of the original signal.

12-14. (canceled)

15. A method according to claim 8, further comprising, after the step of determining an optimal context function associated to the samples to be processed, the steps of:
filtering the samples to be processed to obtained a set of filtered samples,
verifying whether a third criterion is satisfied, and
in case of positive verification, iterating the steps of determining an optimal context function and of filtering the samples to be processed, wherein the samples to be processed consist in the set of filtered samples.

16. A method according to claim 15, wherein in case of negative verification, the number of iterations carried out is recorded in the side information signal.

17. A method according to claim 15, wherein the third criterion is the improvement of a rate-distortion cost calculated using the set of filtered samples as compared to a rate-distortion cost previously memorized.

18. (canceled)

19. Method for decoding a digital signal from a bitstream comprising an encoded digital signal and a side information signal, comprising the steps of:
obtaining, from the encoded digital signal, a source signal at a given target resolution,
dividing samples of the source signal into at least two subsets of samples, the subsets corresponding respectively to different spatial grids that are arranged so that at least some samples of one subset are interleaved spatially with at least some samples of another said subset, and, for each said subset:
obtaining from the side information signal, for at least one sample of the subset, an information representative of a filter amongst a set of predetermined filters
filtering said at least one sample using the filter obtained.

20. Signal processing device comprising:
a receiving unit for receiving an output encoded signal obtained from an original digital signal having an initial spatial resolution and an initial bit rate, the output encoded signal having a bitrate lower than the initial bitrate,
a processing unit for processing the output encoded signal to obtain a source signal having the initial spatial resolution,
a dividing unit for dividing samples of the source signal into at least two subsets of samples, the subsets corresponding respectively to different spatial grids that are arranged so that at least some samples of one subset are interleaved spatially with at least some samples of another said subset,
a determining unit for determining, for at least one sample of the subset, at least one filter amongst a set of predetermined filters according to a first predetermined criterion,
an insertion unit for inserting in a side information signal information representative of the filter(s) determined for the samples of the subset concerned.

21. Device for decoding a digital signal from a bitstream comprising an encoded digital signal and a side information signal, comprising:
a source signal acquisition unit for obtaining, from the encoded digital signal, a source signal at a given target resolution,
a dividing unit for dividing samples of the source signal into at least two subsets of samples, the subsets corresponding respectively to different spatial grids that are arranged so that at least some samples of one subset are interleaved spatially with at least some samples of another said subset, and, for each said subset:
a side information acquisition unit for obtaining from the side information signal, for at least one sample of the subset, an information representative of a filter amongst a set of predetermined filters, and
a filter unit for filtering said at least one sample using the filter obtained.

22. A non-transitory computer readable medium storing a program which, when executed on a computer or processor causes that computer or processor to implement a signal processing method comprising:
receiving an output encoded signal obtained from an original digital signal having an initial spatial resolution and an initial bit rate, the output encoded signal having a bitrate lower than the initial bitrate,
processing the output encoded signal to obtain a source signal having the initial spatial resolution,
dividing samples of the source signal into at least two subsets of samples, the subsets corresponding respectively to different spatial grids that are arranged so that at least some samples of one subset are interleaved spatially with at least some samples of another said subset,
and, for each said subset;
determining for at least one sample of the subset, at least one filter amongst a set of predetermined filters according to a first predetermined criterion,
inserting, in a side information signal, information representative of the filter(s) determined for the samples of the subset concerned.

23. A non-transitory computer readable medium storing a program which, when executed on a computer or processor causes that computer or processor to implement a method for decoding a digital signal from a bitstream comprising an encoded digital signal and a side information signal, comprising:
obtaining from the encoded digital signal, a source signal at a given target resolution,
dividing samples of the source signal into at least two subsets of samples, the subsets corresponding respectively to different spatial grids that are arranged so that at least some samples of one subset are interleaved spatially with at least some samples of another said subset, and, for each said subset:
obtaining from the side information signal, for at least one sample of the subset, an information representative of a filter amongst a set of predetermined filters
filtering said at least one sample using the filter obtained.

24.-27. (canceled)

28. Method for encoding information representative of filters for filtering a digital signal, wherein a filter to be applied to a sample of the digital signal is determined as a function of the value of a context function for said sample, wherein a context function is a function that, for a given sample, takes into account a predetermined number of other samples and outputs a context value amongst a predetermined number of context values,
comprising the steps of:
dividing samples of the digital signal into at least two subsets of samples, the subsets corresponding respectively to different spatial grids that are arranged so that at least some samples of one said subset are interleaved spatially with at least some samples of another said subset,
for each said subset of samples, determining an optimal context function associated with the subset of samples concerned according to a first criterion, and a subset of filters associated to said optimal context function,
grouping items of information representative of the determined filters as a function of the corresponding optimal context function and the subset of samples into side information sub-signals, and
encoding each side information sub-signal thus obtained.

29. A method according to claim 28, wherein in the encoding step, at least two side information sub-signals are encoded independently.

30. A method according to claim 28, further comprising, before the step of dividing samples of the digital signal, a step of dividing the digital signal into blocks of samples, wherein the steps of dividing the samples into at least two subsets and of determining an optimal context function are applied for each block of samples.

31. A method according to claim 28, wherein a filter table is associated to the optimal context function determined, a filter being associated to each possible context value.

32. A method according to claim 28, further comprising, after the step of determining an optimal context function associated to said subset of samples to be processed, the steps of:
filtering said samples to be processed to obtained a set of filtered samples,
verifying whether a rate-distortion cost calculated using the set of filtered samples is improved as compared to a rate-distortion cost previously memorized,
in case of positive verification, iterating the steps of determining an optimal context function and of filtering said samples to be processed, wherein said samples to be processed consist in the set of filtered samples.

33. A method according to claim 32, wherein in case of negative verification, the number of iterations carried out is inserted in a first side information sub-signal and said first side information signal is encoded independently.

34. A method according to claim 28, further comprising a step of gathering the indexes of the optimal context functions determined in a second side information sub-signal and encoding said second sub-signal independently.

35. (canceled)

36. Device for encoding information representative of filters for filtering a digital signal, wherein a filter to be applied to a sample of the digital signal is determined as a function of the value of a context function for said sample, wherein a context function is a function that, for a given sample, takes into account a predetermined number of other samples and outputs a context value amongst a predetermined number of context values,
comprising:
a dividing unit for dividing the samples of the digital signal into at least two subsets of samples, the subsets corresponding respectively to different spatial grids that are arranged so that at least some samples of one said subset are interleaved spatially with at least some samples of another said subset,
a determining unit, for determining an optimal context function associated with the subset of samples concerned according to a first criterion, and a subset of filters associated to said optimal context function,
a grouping unit for grouping items of information representative of the determined filters as a function of the corresponding optimal context function and the subset of samples into side information sub-signals, and
an encoding unit for encoding each sub-signal thus obtained.

37. A non-transitory computer readable medium storing a program which, when executed on a computer or processor causes that computer or processor to implement a method of encoding information representative of filters for filtering a digital signal, wherein a filter to be applied to a sample of the digital signal is determined as a function of the value of a context function for said sample, wherein a context function is a function that, for a given sample, takes into account a predetermined number of other samples and outputs a context value amongst a predetermined number of context values, said method comprising:
dividing samples of the digital signal into at least two subsets of samples, the subsets corresponding respectively to different spatial grids that are arranged so that at least some samples of one said subset are interleaved spatially with at least some samples of another said subset,
for each said subset of samples, determining an optimal context function associated with the subset of samples concerned according to a first criterion, and a subset of filters associated to said optimal context function,
grouping items of information representative of the determined filters as a function of the corresponding optimal context function and the subset of samples into side information sub-signals, and
encoding each side information sub-signal thus obtained.

38-40. (canceled)
